(19) United States
(12) Patent Application Publication
(10) Pub. No.: US 2024/0355611 A1
(43) Pub. Date: Oct. 24, 2024

(54) Extending Operational Lifetime of a Mass Spectrometer

(71) Applicant: DH Technologies Development Pte. Ltd., Singapore (SG)

(72) Inventors: David M. COX, Toronto (CA); Mircea GUNA, Toronto (CA); Yang KANG, Richmond Hill (CA); Mircea MANOLESCU, Concord (CA); Andrei SONOC, Richmond Hill (CA)

(21) Appl. No.: 18/685,534

(22) PCT Filed: Aug. 23, 2022
(86) PCT No.: PCT/IB2022/057895

§ 371 Date: Feb. 22, 2024

Related U.S. Application Data
(60) Provisional application No. 63/236,394, filed on Aug. 24, 2021.

(51) Int. Cl. H01J 49/42

(52) U.S. Cl. CPC H01J 49/421

(57) ABSTRACT

An ion mass filter for use in a mass spectrometer is disclosed, which includes a plurality of rods arranged in a multipole configuration to provide a passageway through which ions can travel, said plurality of rods being configured for application of RF voltages thereto to generate an electromagnetic field within the passageway for providing radial confinement of the ions and further configured for application of a DC voltage thereto, and at least two pairs of auxiliary electrodes interspersed between the plurality of multipole rods, where one pair forms a first pole of the auxiliary electrodes and the other pair forms a second pole of the auxiliary electrodes. A controller can provide one or more control signals to the DC voltage source so as to switch the polarity of the DC voltage differential between the two poles according to a predefined criterion.

### RELATED APPLICATIONS

The present application claims priority to a provisional application entitled EXTENDING OPERATIONAL LIFETIME OF A MASS SPECTROMETER having application No. 63/236,394 filed on Aug. 24, 2021, which is incorporated by reference herein in its entirety.

### BACKGROUND

The present teachings are generally directed to systems and methods for mass spectrometry, and more particularly, to systems and methods for extending an operational lifetime of a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

Ion mass filters are used in a variety of mass spectrometers for selecting ions of interest. For example, some mass filters employ a plurality of rods and/or electrodes to which RF and/or DC voltages can be applied to provide stable ion trajectories for certain ions of interest and unstable ion trajectories for other ions. In such mass filters, unstable ions can be deposited on one or more of the rods and/or electrodes of the mass filter, thereby causing contamination thereof.

### SUMMARY

In one aspect, an ion mass filter for use in a mass spectrometer is disclosed, which includes a plurality of rods arranged in a multipole configuration to provide a passageway through which ions can travel, said plurality of rods being configured for application of RF voltages thereto to generate an electromagnetic field within the passageway for providing radial confinement of the ions and further configured for application of a DC voltage thereto. The ion mass filter can further include at least two pairs of auxiliary electrodes that are interspersed between the plurality of rods, where one pair forms a first pole and the other pair forms a second pole of the auxiliary electrodes. At least a first DC voltage source can apply DC bias voltages to the first and second poles of the auxiliary electrodes. A controller in communication with the DC voltage source can cause the DC voltage source to adjust the bias voltages applied to the first and the second poles so as to switch the polarity of a voltage difference between the two poles, which is herein also referred to as ΔTbar, or Tbar delta, e.g., according to one or more predefined criteria. For example, the bias voltage applied to each pole (i.e, applied to the two auxiliary electrodes of each pole) can be considered as having a DC offset voltage component and a DC auxiliary voltage component such that the voltage difference between the two poles is ΔTbar.

For example, at any given time, the bias voltage applied to one pole can be defined as follows:

$$Bias DC voltage = DC offset + Δ Tbar / 2 \qquad Eq . ( 1 )$$

and the bias voltage applied to the other pole can be defined as follows:

$$Bias DC voltage = DC offset - Δ Tbar / 2 \qquad Eq . ( 2 )$$

where ΔTbar denotes the voltage difference between the two poles. The controller can affect switching the polarity of the ΔTbar, e.g., according to a predefined criterion, so as to change the pole on which the ions having unstable trajectories are deposited.

By way of example, and without limitation, such predefined criteria can include a threshold associated with the total number of ions detected by an ion detector of a mass spectrometer in which the ion filter is incorporated, a predefined temporal schedule, or a parameter associated with the performance of the mass spectrometer. In some embodiments, the controller is configured to cause the DC voltage source to switch the polarity of the DC bias voltage difference between the two poles of the auxiliary electrodes in successive sample runs. Further, in some embodiments, the controller is configured to cause the DC voltage source to switch the polarity of the DC bias voltage difference between the two poles when a degradation in the performance of the ion filter is detected (e.g., when a signal intensity falls below a threshold).

By way of example, a shift in the bandpass window of the ion filter and/or substantial changes in the tuning conditions due to contamination can lead to a loss in the mass signal of a target ion. In some embodiments, the DC voltage source can include two independent DC power supplies each of which is configured to apply bias voltages to one of the poles. The controller can control these DC power supplies to change the polarity of the bias voltage differential applied to the poles.

In some embodiments, a second voltage source can apply a DC voltage to the multipole rods.

The DC bias voltages applied to the auxiliary electrodes are configured relative to the DC voltage applied to the plurality of multipole rods such that ions having m/z ratios within a target range experience stable trajectories as they pass through the passageway and ions having m/z ratios outside that target range experience unstable trajectories so as to be deposited on one of the poles of the auxiliary electrodes based on the polarity of the electric charge of the ions and the polarity of the DC bias voltage difference between the two poles of the auxiliary electrodes.

In some embodiments, the controller can be configured to switch the polarity of the DC bias voltage difference between the two poles so as to ensure a substantially equal accumulation of the unstable ions on the two poles, thereby inhibiting a substantial change in the performance of the two poles.

In some embodiments of the ion filter, the plurality of the auxiliary electrodes includes four rods that are arranged in a quadrupole configuration such that each of the auxiliary electrodes is interposed between two of the plurality of the rods.

The auxiliary electrodes can have a variety of different shapes. By way of example, the auxiliary electrodes can be T-shaped, or blade-shaped, among others. By way of example, a T-shaped electrode can include a backplate (e.g., a backplate having a square cross section) from which a stem extends. Such a T-shaped electrode can be positioned such that the stem extends toward a central longitudinal axis of the ion filter.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz. In some such embodiments, the RF voltages can have an amplitude in a range of about 10 volts to about 5 kilovolts (V 0-p), e.g., in a range of about 100 to 2000 V₀₋ₚ, or in a range of about 2000 to 5000 V₀₋ₚ. In some embodiments, the DC bias voltages applied to the auxiliary electrodes have an amplitude in a range of about −8500 volts to about +8500 volts, e.g. in a range of about −1000 V to about +1000 V, in a range of about −3000 V to +3000 V, in a range of about −7000 V to +7000 V.

In a related aspect, a mass spectrometer is disclosed, which includes an ion filter having a plurality of rods arranged in a multipole configuration to provide a passageway through which ions can travel, said plurality of rods being configured for application of RF voltages thereto to generate an electromagnetic field within the passageway for providing radial confinement of the ions and further configured for application of a DC voltage thereto. At least two pairs of auxiliary electrodes are interspersed between the plurality of rods and are configured for application of DC bias voltages thereto. The DC bias voltages applied to the auxiliary electrodes are configured relative to the DC voltage applied to the plurality of rods such that ions having m/z ratios within a target range experience stable trajectories as they pass through the passageway and ions having m/z ratios outside the target range experience unstable trajectories so as to be deposited on one of said pairs of the auxiliary electrodes based on the polarity of the electric charge of the ions and the polarity of the DC bias voltage differential between those pairs of the auxiliary electrodes.

For example, at least a portion of the unstable positively-charged ions can be deposited on the pair of the auxiliary electrodes that is maintained at a negative DC bias voltage relative to the other pair and at least a portion of the unstable negatively-charged ions can be deposited on the pair of the auxiliary electrodes that is maintained at a positive DC bias voltage relative to the other pair. By switching the polarity of the DC voltage difference between the two poles, the pole on which the unstable ions are deposited can be changed.

The mass spectrometer can include at least one RF voltage source for applying RF voltages to the multipole rods for providing radial confinement of the ions passing through the ion filter, and at least one DC voltage source for applying a DC voltage to the multipole rods and for applying DC bias voltages to the auxiliary electrodes. In some embodiments, the mass spectrometer can include two independent DC voltage sources, where one of the DC voltage sources is configured for application of a DC voltage to the multipole rods and the other DC voltage source is configured for application of DC bias voltages to the auxiliary electrodes.

A controller can be in communication with said at least one DC voltage source, where the controller is configured to cause said DC voltage source to switch the polarity of the DC bias voltage differential applied between the poles of the auxiliary electrodes so as to change the pair of the auxiliary electrodes on which the unstable ions are deposited.

Further, in some embodiments, the DC voltage source configured for application of DC voltages to the poles of the auxiliary electrodes can include two independent power supplies, where each power supply is configured for application of DC voltages to one pole of the auxiliary electrodes.

The controller can be configured to cause the DC voltage source to switch the polarity of the DC bias voltage differential between the two poles according to one or more predefined criteria. By way of example, the controller can be configured to cause the DC voltage source to switch the polarity of the DC bias voltage differential between the two poles when the number of ions detected by an ion detector of a mass spectrometer in which the ion filter is incorporated exceeds a predefined threshold. In some cases, the controller can cause the switching of the polarity of the DC voltage differential between the two poles in successive sample runs.

In a related aspect, a method for operating an ion filter incorporated in a mass spectrometer is disclosed, where the ion filter comprises a plurality of rods arranged in a multipole configuration to provide a passageway through which ions can travel, and at least two pairs of auxiliary electrodes interspersed between said plurality of rods. The method includes applying RF voltages to the plurality of the multipole rods to generate an electromagnetic field in the passageway for radial confinement of ions passing through the passageway, applying DC bias voltages to the auxiliary electrodes such that ions having m/z ratios within a target range experience stable trajectories as the ions pass through the passageway and ions having m/z ratios outside the target range experience unstable trajectories so as to be deposited on one of said pairs of auxiliary electrodes, and adjusting the DC bias voltages applied to said two pairs of the auxiliary electrodes so as to change the pair of the auxiliary electrodes on which unstable ions are deposited. In some embodiments, the adjustment of the DC bias voltages can be achieved by switching the polarity of the DC bias voltage differential between the two poles of the auxiliary electrodes.

In some embodiments, the switching of the polarity of DC bias voltage differential is performed in accordance with one or more predefined criteria. By way of example, the one or more predefined criteria can include, without limitation, a maximum number of ions detected by an ion detector of the mass spectrometer, e.g., during a sample run, and a predefined temporal schedule for switching the voltage polarity. In some embodiments, the polarity of the DC bias voltage differential can be switched in successive sample runs.

Further understanding of various aspects of the present teachings can be obtained via reference to the following detailed description and the associated drawings, which are described briefly below.

### BRIEF DESCRIPTION OF THE DRAWINGS

FIG. 1 is a flow chart depicting various steps in an embodiment of a method according to the present teachings for operating an ion mass filter for use in a mass spectrometer,

FIGS. 2A and 2B schematically depict an ion mass filter according to an embodiment of the present teachings,

FIG. 3A schematically shows the attraction of positively-charged ions to the B pole of the ion filter, when the B pole is maintained at a negative DC potential,

FIG. 3B schematically shows the attraction of positively-charged ions to the A pole of the ions filter in response to the switching of the polarity of the DC voltage so as to change the polarity of the voltage applied to the A pole from a negative polarity to a positive polarity,

FIG. 4A schematically depicts a mass spectrometer according to an embodiment of the present teachings,

FIG. 4B schematically depicts the use of a D Jet™ ion guide in addition to a QJet® ion guide in the mass spectrometer depicted in FIG. 4A,

FIG. 5 shows an example of an implementation of a controller suitable for use in the practice of the present teachings,

FIGS. 6A-6D show a plurality of MRM measurements associated with six ions, and

FIGS. 7A and 7B show linear relationships between the potential difference between the two poles of an ion filter according to an embodiment and the mass of the precursor ion passing through a downstream mass analyzer.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Various terms are used herein in accordance with their ordinary meanings in the art. For example, the term “ion mass filter” and “ion filter” are used herein interchangeably to refer to a structure that can be employed, for example, in a mass spectrometer, for limiting the transmission of ions to those having a target m/z ratio or an m/z ratio within a target range. The terms “mechanical misalignment” and “misalignment” are used herein interchangeably to refer to a deviation of one or more components of an ion mass filter relative to its nominal position (i.e., relative to the intended position). Such a misalignment can occur along a longitudinal direction of the ion mass filter and/or along a radial direction (i.e., a direction perpendicular to the longitudinal direction) of the mass filter.

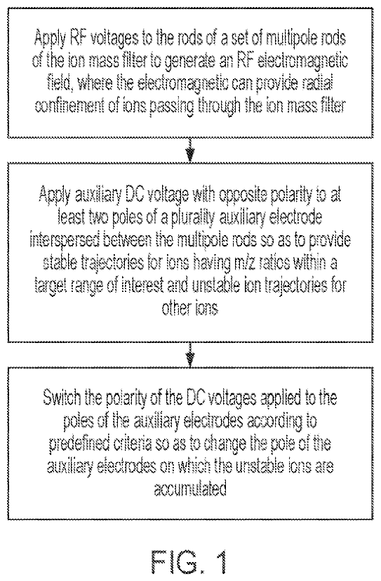

With reference to the flow chart of FIG. 1, in one aspect, the present teachings provide a method for extending the useful lifetime of an ion filter in a mass spectrometer, where the ion filter includes a set of rods that are arranged according to a multipole configuration (e.g., a quadrupole configuration) and are spaced apart to provide a passageway through which ions can travel. The ion mass filter can also include a plurality of auxiliary electrodes, e.g., a plurality of T-shaped auxiliary electrodes, that are interspersed between the multipole rods such that each auxiliary electrode is interposed between two of the multipole rods. The rods can be characterized as comprising a plurality of pairwise poles where the voltages applied to the rods of each pole are substantially equal (the rods of each pole are equipotential) while different voltages are applied between the poles.

By way of illustration and without any loss of generality, in this embodiment, it is assumed that the multipole rods include two pairs of rods that are arranged relative to one another according to a quadrupole configuration. RF voltages having the same amplitudes are applied to the quadrupole rods with the voltage applied to one pair of the rods having a 180-degree phase shift relative to the RF voltage applied to the other pair of the quadrupole rods. The RF voltages applied to the quadrupole rods generate a quadrupolar electromagnetic field within the ion passageway that can facilitate the radial confinement of the ions.

In some embodiments, the RF voltages applied to the multipole rods can have a frequency in a range of about 0.1 MHz to about 5 MHz, e.g., in a range of about 1 MHz to about 3 MHz, or in a range of about 3 MHz to about 5 MHz. In some such embodiments, the RF voltages can have an amplitude in a range of about 10 volts to about 5 kilovolts (V₀₋ₚ), e.g., in a range of about 100 to 2000 V₀₋ₚ, or in a range of about 2000 to 5000 V₀₋ₚ. In some embodiments, the DC bias voltages applied to the auxiliary electrodes have an amplitude in a range of about −8500 volts to about +8500 volts, e.g. in a range of about −1000 volts to about +1000 volts, in a range of about −3000 volts to +3000 volts, in a range of about −7000 volts to +7000 volts.

With continued reference to the flow chart of FIG. 1, DC voltages are applied to the auxiliary electrodes so as to cause ions having m/z ratios within a target range to have stable trajectories while ions having m/z ratios outside that target range will experience unstable trajectories and at least a portion thereof will be deposited on a pole having a voltage polarity that is opposite to that of the charge polarity of the ions.

In some embodiments, the DC voltages applied to the auxiliary electrodes can provide a low-pass filter allowing the transmission of ions having m/z ratios less than a threshold. In other words, the DC potential difference between the auxiliary electrodes (as well as the potential difference between the auxiliary electrodes and the quadrupole rods) can generate a DC electromagnetic field that can cause one or more target ions (i.e., ions of interest) to have stable ion trajectories as they pass through the ion mass filter and cause other ions to have unstable ion trajectories. The unstable ions are attracted to the pair of the auxiliary electrodes that is maintained at a potential having a polarity opposite to the polarity of the ion charge, thus resulting in the accumulation of the unstable ions on that pair of the auxiliary electrodes.

The method further calls for switching the polarity of the voltage difference between the two poles of the auxiliary electrodes according to a predefined criterion so as to change the pair of the auxiliary electrodes on which the unstable ions are accumulated. In embodiments, such switching of the polarity of the voltages can result in substantially similar accumulation of the unstable ions on the two pairs of the auxiliary electrodes, thereby minimizing, and preferably eliminating, a difference in the performance of the two poles of the auxiliary electrodes as a result of unequal accumulation of unstable ions thereon.

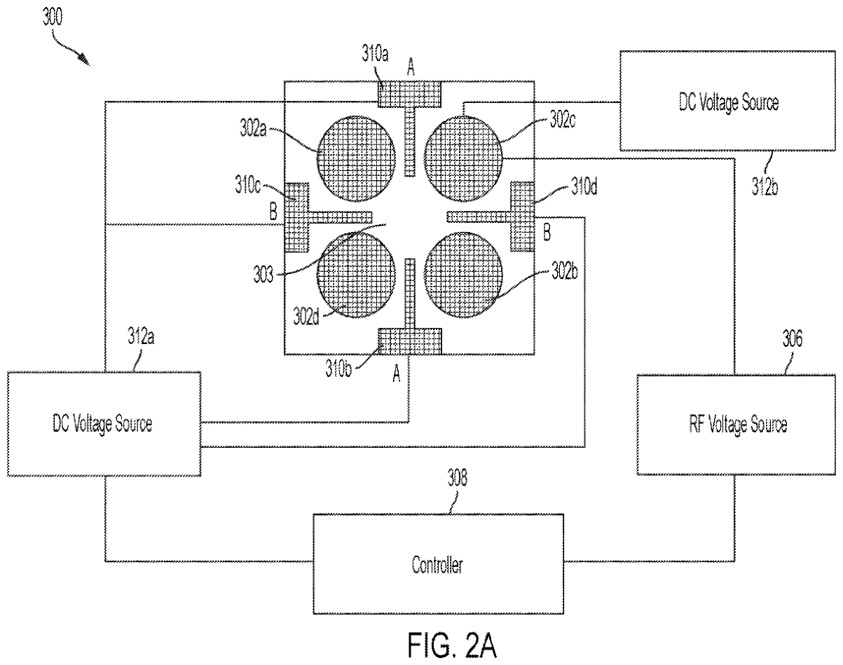

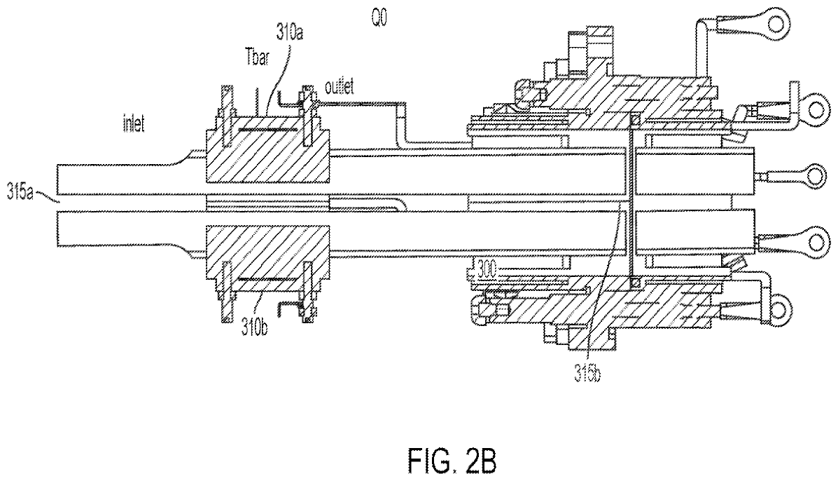

FIGS. 2A and 2B schematically depict an ion mass filter 300 according to an embodiment of the present teachings, which includes four rods 302a, 302b, 302c, and 302d that are arranged relative to one another in a quadrupole configuration (herein referred to collectively as the quadrupole rods 302) to provide a passageway 303 therebetween, where the passageway extends from an inlet 315a through which ions can enter the passageway to an outlet 315b through which ions can exit the passageway.

An RF voltage source 306 operating under the control of a controller 308 applies RF voltages to the quadrupole rods so as to generate a quadrupolar electromagnetic field within the passageway, which can facilitate the radial confinement of the ions as they pass through the passageway. The ions can also undergo collisional cooling as they pass through the passageway, e.g., via collisions with a background gas. The RF voltages applied to the quadrupole rods can also allow filtering out low mass ions (e.g., ions having m/z ratios less than about 500, or less than about 300, or less than about 100).

In this embodiment, the RF voltages applied to the rod pairs (302a/302b) and (302c/302d) have substantially the same amplitude but opposite polarities.

The mass filter 300 further includes a plurality of T-shaped auxiliary electrodes 310a, 310b, 310c, and 310d (herein collectively referred to as the T-shaped auxiliary electrodes 310 or T-bar electrodes 310), where each of the T-bar electrodes is interposed between two of the quadrupole electrodes 302.

The pair of the auxiliary electrodes 310a and 310b forms one pole of the auxiliary electrodes (herein referred to as the A-pole) and the pair of the auxiliary electrodes 310c and 310d forms another pole of the auxiliary electrodes (herein referred to as the B-pole).

A DC voltage source 312b applies a DC voltage to the quadrupole rods 302. In some embodiments, the DC voltage applied to the quadrupole rods 302 can generate a DC voltage offset between the quadrupole rods and an upstream and/or a downstream component of the mass spectrometer (e.g., an upstream ion guide and/or a downstream mass filter).

In this embodiment, another DC voltage source 312a applies DC voltages to the T-bar auxiliary electrodes 310. The DC voltages applied to the quadrupole rods 302 and the T-bar auxiliary electrodes 310 result in the generation of an octupolar DC electric field distribution within the passageway that allows for the transmission of ions with m/z ratios within a target range while inhibiting the transmission of ions with m/z ratios outside that target range. In other words, the electric field generated within the passageway can cause certain ions to experience stable trajectories and hence be transmitted through the passageway while other ions experience unstable trajectories and may be deposited on the T-bar electrodes and/or the quadrupole rods.

As discussed above, the DC electric field distribution can provide a low pass mass filter by inhibiting transmission of ions having m/z ratios above a threshold. Further, the RF field generated as a result of the application of RF voltages to the quadrupole rods can generate a high pass mass filter by inhibiting the transmission of low mass ions (e.g., ions having m/z ratios less than about 500, or less than about 300, or less than about 100) through the ion mass filter. In this manner, the combination of the quadrupole rods and the auxiliary electrodes with RF and DC voltages applied thereto can provide a bandpass ion filter that allows the passage of ions having m/z ratios within a transmission window therethrough.

The DC voltage applied to the A-pole and the B-pole of the T-shaped auxiliary electrodes can repel or attract the ions passing through the ion mass filter based on the relative polarity of that DC voltage with respect to the polarity of the ion charge.

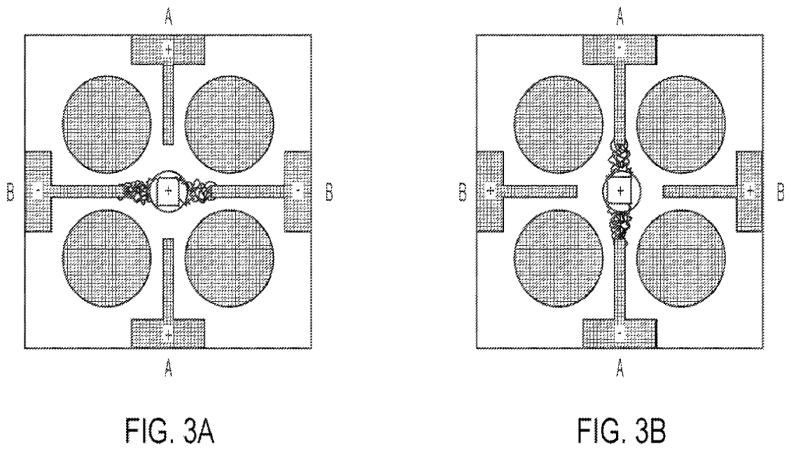

In particular, the ions experiencing unstable trajectories are drawn to the pair of the auxiliary electrodes that is maintained at a DC potential having a polarity that is opposite to the charge polarity of the unstable ions. By way of example, FIG. 3A shows that when the A pole is maintained at a positive DC potential relative to the quadrupole rod offset and the B pole is maintained at a negative DC potential relative to the quadrupole rod offset, positively-charged ions that experience unstable trajectories are attracted to the B-pole and hence are deposited on that pole.

FIG. 3B schematically shows that when the polarity of the DC voltage differential between the A and B poles is switched such that the A-pole is maintained at a negative DC potential relative to the quadrupole rod offset and the B-pole is maintained at a positive DC potential relative to the quadrupole rod offset, the positively-charged ions experiencing unstable trajectories are attracted to the B-pole and are hence deposited on that pole. As discussed in more detail below, in embodiments, such switching of the polarity of the DC voltage differential applied to the A-pole and the B-pole can be utilized to ensure that the unstable ions are not deposited only on one pair of the auxiliary electrodes (i.e., only on one pole), but rather are distributed on both poles, thereby increasing the useful lifetime of the ion filter.

For example, referring again to FIG. 2A, the controller 308 can be programmed to switch the polarity of the DC voltage differential applied between the A-pole and the B-pole of the ion filter 300 according to a predefined criteria, e.g., to ensure a substantially equal deposition of the unstable ions (i.e., ions experiencing unstable trajectories due to their interaction with the electromagnetic field generated within the ion filter).

By way of example, the controller 308 can be programmed to switch the polarity of the DC voltage differential between the A-pole and the B-pole of the auxiliary electrodes based on a predefined temporal schedule, e.g., in a range of about 5 to 20 milliseconds. Alternatively, the controller 308 can be programmed to switch the polarity of the DC voltage differential between the A-pole and the B-pole of the auxiliary electrodes based on the number of ions that are detected by a downstream ion detector of a mass spectrometer in which the ion filter 300 is incorporated. For example, in one such embodiment, when the number of the detected ions exceeds a predefined threshold, the controller 308 can send a control signal to the DC voltage source to generate voltages so as to switch the polarity of the DC voltage differential applied between the A-pole and the B-pole of the auxiliary electrodes.

In yet another embodiment, the controller 308 can be programmed to switch the polarity of the DC voltage differential between the A-pole and the B-pole of the auxiliary electrodes in response to a degradation of the performance of the mass spectrometer. By way of example, as discussed in more detail below, the controller 308 can monitor the intensity of a signal associated with one or more calibrant ions and adjust the voltage outputs so as to switch the polarity of the DC voltage differential between the A-pole and the B-pole of the auxiliary electrodes when the monitored intensity falls below a predefined threshold due to bandpass window shifts.

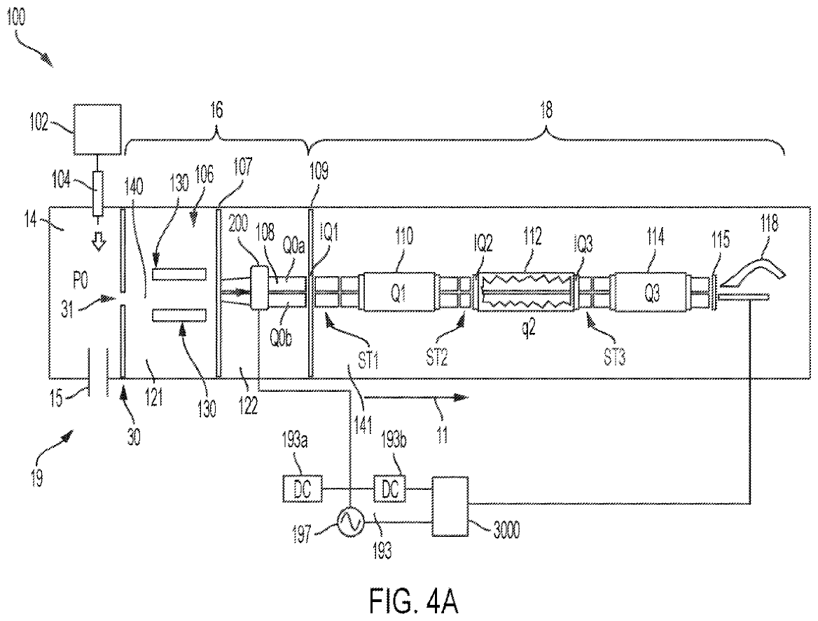

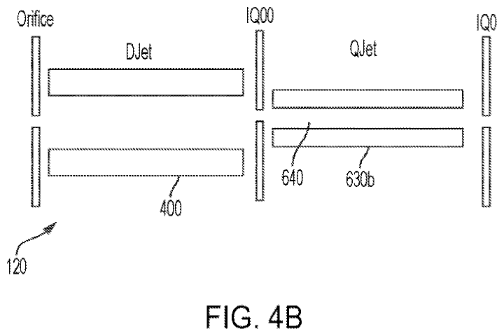

An ion mass filter according to the present teachings can be incorporated in a variety of mass spectrometers. By way of example, with reference to FIGS. 4A and 4B, a mass spectrometer 100 according to an embodiment of the present teachings includes an ion source 104 that receives a sample from a sample source 102 and generates a plurality of ions that are introduced into an chamber 14, which is evacuated via a port 15.

At least a portion of the ions pass through an orifice 31 of an orifice plate 30 into a chamber 121 in which an ion guide 140 (herein also referred to as QJet® ion guide) is disposed.

The chamber 121 can be maintained, for example, at a pressure in a range of about 1 Torr to about 3 Torr. The QJet® ion guide includes four rods (two of which 130 are visible in the figure) that are arranged according to a quadrupole configuration to provide a passageway therebetween through which the ions can pass through the ion guide. RF voltages can be applied to the rods of the QJet® ion guide, e.g., via capacitive coupling to a downstream ion guide Q0 discussed further below or via an independent RF voltages source, for radially confining, and focusing the ions for transmission to a downstream chamber 122 in which an ion filter 108 according to an embodiment of the present teachings is disposed.

An ion lens 107 to which a DC voltage is applied separates the vacuum chamber 122 from the vacuum chamber 121 and helps focus the ions exiting the vacuum chamber 121 into the vacuum chamber 122.

The chamber 122 can be maintained at a pressure lower than the pressure at which the chamber 121 is maintained. By way of example, the chamber 122 can be maintained at a pressure in a range of about 2 mTorr to about 15 mTorr. In this embodiment, the ion filter 108 includes an ion guide Q0 having four rods (two of which Q0a and Q0b are visible in the figure). An RF voltage source 197 applies RF voltages to the rods of the Q0 ion guide for providing radial confinement of the ions passing therethrough.

The ion filter 108 further includes a plurality of T-shaped auxiliary electrodes 200 that are interspersed between the rods of the Q0 ion guide such that each of the auxiliary electrodes is interposed between two of the rods, e.g., in a manner discussed above in connection with FIG. 2 above.

A DC voltage source 193a applies a DC voltage to the rods of the Q0 ion guide, where the applied DC voltage generates a DC voltage offset between the Q0 ion guide and the upstream QJet® ion guide to accelerate ions exiting the QJet® ion guide into the Q0 ion guide. In this embodiment, another DC voltage source 193b applies DC voltages to the auxiliary electrodes.

A controller 3000 controls the operation of the RF voltage source 197 as well as the DC voltage sources 193a and 193b. In particular, the controller can control the operation of the DC voltage source 193a that applies DC voltages to the A-pole and the B-pole of the auxiliary electrodes so as to switch the polarity of the DC voltage differential between those poles based on predefined criteria, such as those discussed above.

A mass analyzer Q1 110 receives the ions passing through the ion filter via an ion lens IQ1 and one stubby lens ST1. In this embodiment, the mass analyzer Q1 110 includes four rods that are arranged in a quadrupole configuration and to which RF and/or DC voltages can be applied for selecting ions having m/z ratios within a target range. The ions propagating through the mass analyzer Q1 110 (herein referred to as precursor ions) pass through stubby lenses ST2 and ion lens IQ2 to reach a collision cell 112 (q2).

At least a portion of the precursor ions are fragmented in the collision cell 112 to generate a plurality of product ions. The product ions pass through an ion lens IQ3 and a stubby lens ST3 to reach another downstream mass analyzer Q3. In this embodiment, the mass analyzer Q3 includes four rods that are arranged in a quadrupole configuration and to which RF and/or DC voltages can be applied to allow passage of product ions having an m/z ratio of interest. The product ions passing through the mass analyzer Q3 pass through an exit lens 115 to be detected by an ion detector 118. In some embodiments, the quadrupole mass analyzer Q3 can be replaced with a time-of-flight (ToF) mass analyzer or any other suitable mass analyzer.

In some embodiments, the controller 3000 can be in communication with the ion detector 118 to receive ion detection signals and employ one or more of the received ion detection signals to assess the performance of the mass spectrometer. For example, in some embodiments, a calibrant ion or multiple calibrant ions can be introduced into the mass spectrometer on a predefined schedule and at least one mass signal thereof can be measured to assess the performance of the mass spectrometer.

The controller can assess the mass signal and determine whether the performance of the mass spectrometer has degraded below an acceptable level (e.g., by monitoring the intensity of the mass signal). In such a case, the controller can cause the DC voltage source 193a to switch the polarity of the voltage differential between the A-pole and the B-pole.

As shown schematically in FIG. 4B, in some embodiments, a vacuum chamber 120 is positioned between the orifice plate and the evacuated chamber 121. An ion guide 400 (herein also referred to as DJet™ ion guide) is disposed in the evacuated chamber 120. The DJet™ ion guide includes 12 rods that are arranged in a multipole configuration and to which RF voltages can be applied to provide focusing of the ions received via the orifice of the orifice plate. The evacuated chamber 120 can be maintained at a pressure higher than the pressure at which the vacuum chamber 121 is maintained. By way of example, the evacuated chamber 120 can be maintained at a pressure in a range of about 4 Torr to about 8 Torr and the evacuated chamber 122 can be maintained at a pressure in a range of about 1.5 Torr to about 3.3 Torr. An ion lens IQ00 separates the vacuum chamber 120 from the downstream vacuum chamber 121.

A controller for use in controlling RF and/or DC voltages applied to various elements of an ion filter, such as the above controller 3000, and/or other elements of a mass spectrometer in which an ion filter is incorporated, and particularly for controlling the switching of the polarity of the DC voltages applied to the auxiliary electrodes, can be implemented in hardware, firmware and/or software using known techniques as informed by the present teachings.

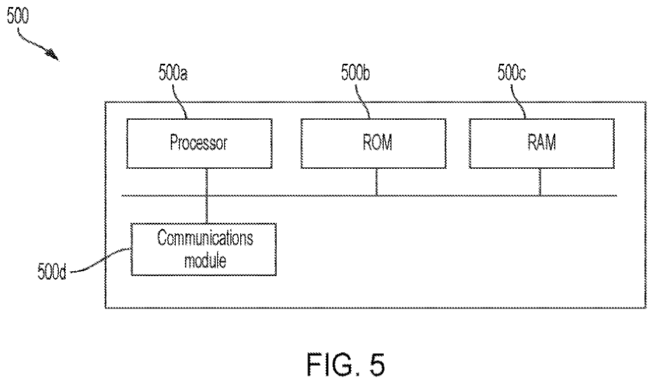

By way of example, FIG. 5 schematically depicts an example of an implementation of such a controller 500, which includes a processor 500a (e.g., a microprocessor), at least one permanent memory module 500b (e.g., ROM), at least one transient memory module (e.g., RAM) 500c, and a bus 500d, among other elements generally known in the art.

The bus 500d allows communication between the processor and various other components of the controller. In this example, the controller 500 can further include a communications module 500e that is configured to allow sending and receiving signals.

Instructions for use by the controller 500, e.g., for adjusting the DC voltages applied to the auxiliary electrodes, can be stored in the permanent memory module 500b and can be transferred into the transient memory module 500c during runtime for execution. The controller 500 can also be configured to control the operation of other components of the mass spectrometer, such as the ion guide, and mass analyzer, among others.

The following examples are provided to further elucidate various aspects of the present teachings and are not provided to necessarily indicate the optimal ways of practicing the present teachings and/or optimal results that may be obtained.

### EXAMPLES

A plurality of MRM transitions of multiple ions were measured using a Sciex 7500® triple quad mass spectrometric system with a 5 ms dwell time and a 5 ms pause. The system included an ion mass filter according to an embodiment of the present teachings having a set of quadrupole rods to which RF voltages at a frequency of 1.228 MHz and 940 kHz and an amplitude of about 3000 volts Vp-p were applied to provide radial confinement of the ions passing through the ion mass filter as well as a plurality of T-bar auxiliary electrodes that were interspersed between the quadrupole rods in a manner discussed herein.

Table 1 below lists the masses of 6 ions for which the MRM transitions were measured, as well as the voltages applied to the A-pole and the B-pole of the auxiliary electrodes and their respective polarities. The parameter T-bar delta indicates the DC potential difference between the A-pole and the B-pole of the auxiliary electrodes, and more specifically, T-bar delta=DC voltage applied to A-pole−(minus) DC voltage applied to B-pole. The T-bar delta was set to a value that resulted in a high mass cutoff (HMCO) that was 100 Da greater than Q1 mass.

TABLE 1

| | Tbar delta (V) | | | | Intensity (cps) | | | |
|---|---|---|---|---|---|---|---|---|
| Q1_m/z | B | A | A to B | B to A | B | A | A to B | B to A |
| 266.1 | 67 | −67 | −67 | 67 | 2.03E+06 | 2.08E+06 | 2.04E+06 | 2.06E+06 |
| 442.2 | 132 | −132 | 132 | −132 | 1.21E+06 | 1.24E+06 | 1.23E+06 | 1.19E+06 |
| 609.3 | 195 | −195 | −195 | 195 | 3.18E+06 | 3.27E+06 | 3.20E+06 | 3.17E+06 |
| 829.5 | 278 | −278 | 278 | −278 | 4.74E+06 | 4.84E+06 | 4.85E+06 | 4.86E+06 |
| 922.0 | 312 | −312 | −312 | 312 | 1.81E+06 | 1.97E+06 | 1.84E+06 | 2.18E+06 |
| 1522.0 | 537 | −537 | 537 | −537 | 1.04E+06 | 1.03E+06 | 1.09E+06 | 1.19E+06 |

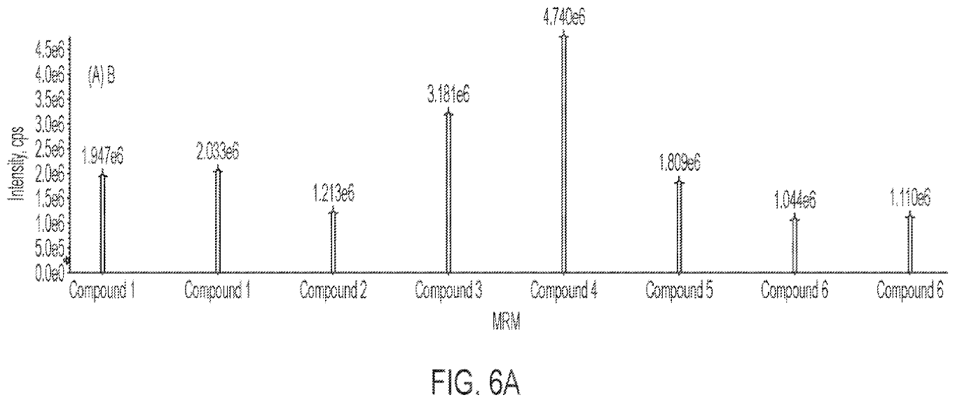

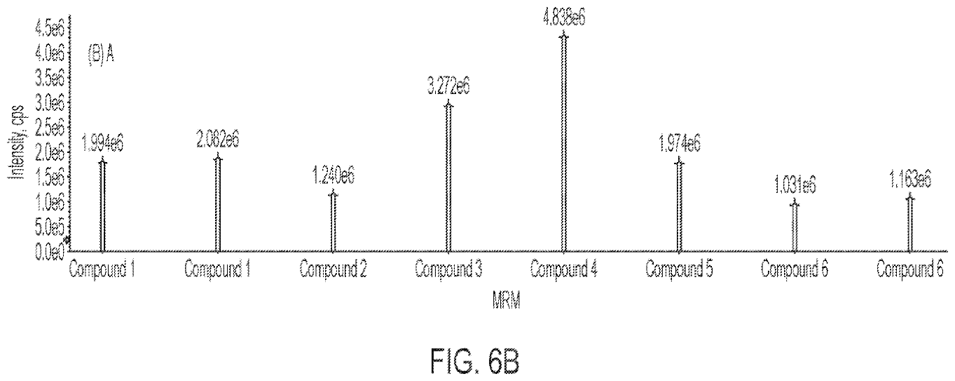

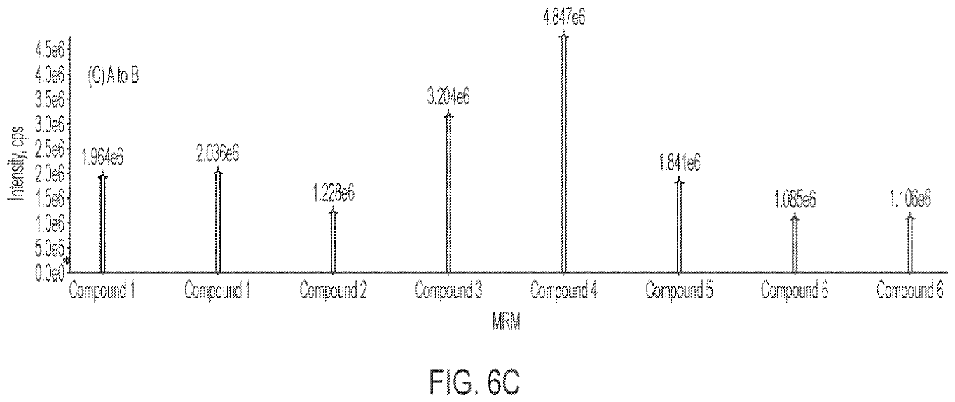

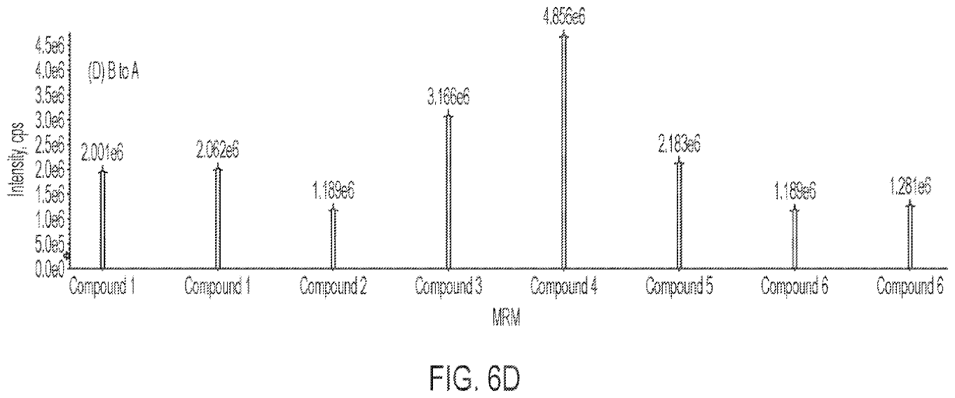

FIGS. 6A-6D show the intensities of the MRM transitions of the above 6 ions measured under different Tbar polarity conditions. The first and last ions were m/z 266 and m/z 1522 with Tbar delta=0. The Tbar conditions for the 2^{nd} to 6^{th} ions (m/z 266.1, 442.2, 609.3, 829.5, 922.0, and 1522.0) follow the information listed in Table 1.

When a positive Tbar delta was applied to the A-pole and the B-pole of the auxiliary electrodes, unstable ions moved to the B-pole and were accumulated on that pole. Conversely, when a negative Tbar delta was applied to the B-pole and the A-pole of the auxiliary electrodes, the unstable ions moved to the A-pole and were accumulated on that pole. The same signal intensities were observed with the unstable ions accumulating on the B-pole, on the A-pole, switching from A to B between MRM signal acquisition (5 ms pause), or switching from B to A between MRM signal acquisition (5 ms pause). No trapping or signal loss was observed for each pole. Further, a linear relationship between Tbar delta and Q1 mass was observed.

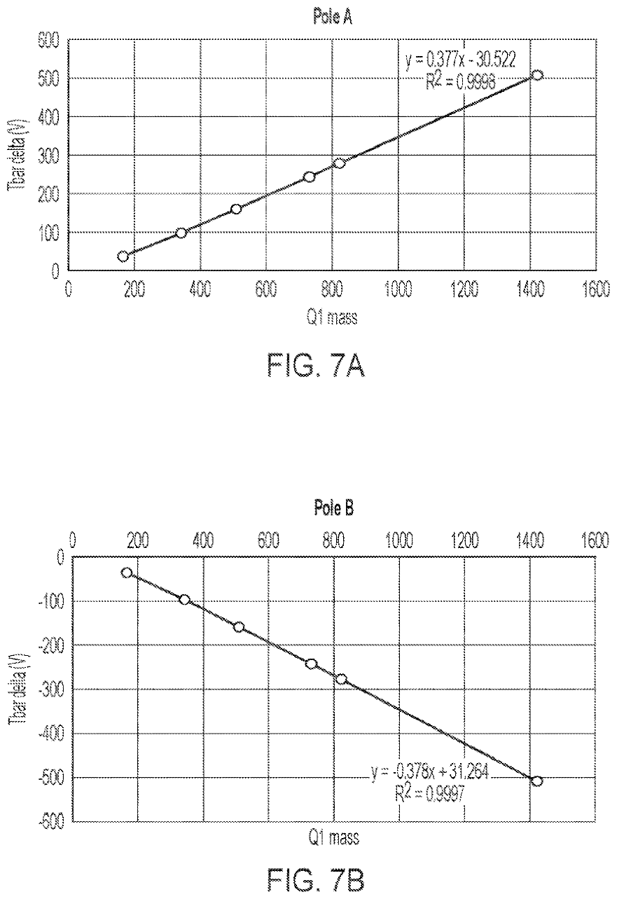

Each of FIGS. 7A and 7B provides a relationship between Tbar delta and precursor mass (Q1 mass) based on MRM transition data acquired on the Sciex 7500® triple quad system. FIG. 7A corresponds to a Tbar delta polarity that results in the accumulation of the unstable ions on the A pole and FIG. 7B corresponds to a Tbar delta polarity that results in the accumulation of the unstable ions on the B pole. The data depicted in FIGS. 7A and 7B show a linear relationship between the Tbar delta and the Q1 mass in both cases.

In some embodiments, consistent Tbar delta versus Q1 mass calibration curve can be used for both poles. In particular, in most cases, with optimized conditions, identical correlations of Tbar delta versus Q1 mass can be applied in both poles. In other embodiments, correlations in Tbar delta versus Q1 mass calibration may be slightly different, and different calibration curves are needed for each pole.

Those having ordinary skill in the art will appreciate that various changes can be made to the above embodiments without departing from the scope of the present teachings.

What is claimed is:

1. An ion mass filter for use in a mass spectrometer, comprising:
a plurality of rods arranged in a multipole configuration to provide a passageway through which ions can travel, said plurality of rods being configured for application of RF voltages thereto to generate an electromagnetic field within said passageway for providing radial confinement of the ions and further configured for application of a DC voltage thereto,
at least two pairs of auxiliary electrodes interspersed between said plurality of rods, wherein one pair forms a first pole of the auxiliary electrodes and the other pair form a second pole of the auxiliary electrodes,
at least a first DC voltage source for applying DC bias voltages to the auxiliary electrodes, and
a controller in communication with said at least one DC voltage source for causing said DC voltage source to switch polarity of a bias voltage differential between said poles according to at least one predefined criterion.

2. The ion mass filter of claim 1, further comprising an RF voltage source configured to apply RF voltages to said plurality of rods.

3. The ion mass filter of claim 1, further comprising at least a second DC voltage source configured to apply a DC voltage to said plurality of rods.

4. The ion mass filter of claim 3, wherein the DC voltage applied to said plurality of rods and the DC bias voltages applied to said auxiliary electrodes are configured to generate an electromagnetic field within said passageway such that an interaction of the ions with the electromagnetic field results in ions having m/z ratios within a target range experiencing stable trajectories and ions having m/z ratios outside said target range experiencing unstable trajectories.

5. The ion mass filter of claim 4, wherein said predefined criterion is configured to allow substantially equal accumulation of the unstable ions on said first and said second pole of the auxiliary electrodes.

6. The ion filter of claim 5, wherein said at least one predefined criterion comprises a maximum number of ions detected by an ion detector of a mass spectrometer in which said ion filter is incorporated.

7. The ion filter of claim 5, wherein said at least one predefined criterion comprises a predefined temporal schedule for switching the polarity of the bias DC voltage differential between the first and the second poles of the auxiliary electrodes.

8. The ion filter of claim 1, wherein said controller is configured to cause the first DC voltage source to switch the polarity of the DC bias voltage differential between the first and the second poles of the auxiliary electrodes in successive sample runs.

9. The ion filter of claim 1, wherein said controller is configured to cause the first DC voltage source to switch the polarity of the DC bias voltage differential between the first and the second poles in response to detection of a degradation in performance of said ion filter.

10. The ion filter of claim 1, wherein said plurality electrodes comprises four rods arranged in a quadrupole configuration such that each of said auxiliary electrodes is disposed between two of said plurality of rods.

11. The ion filter of claim 1, wherein said auxiliary electrodes comprise a plurality of T-shaped auxiliary electrodes.

12. The ion filter of claim 11, wherein each of said T-shaped auxiliary electrodes comprises a backplate and a stem extending radially from said backplate.

13. The ion filter of claim 1, wherein said RF voltages have a frequency in a range of about 0.1 MHz to about 5 MHz.

14. The high pass filter of claim 13, wherein said RF voltages have an amplitude in a range of about 10 volts to about 5 kilovolts.

15. The ion filter of claim 1, wherein said DC voltage applied to said plurality of multipole rods is in a range of about −250 volts to about +250 volts.

16. The ion filter of claim 15, wherein said DC bias voltages are in a range of about −8 kilovolts volts to about +8 kilovolts.

17. A mass spectrometer, comprising:
an ion filter comprising:
a plurality of rods arranged in a multipole configuration to provide a passageway through which ions can travel, said plurality of rods being configured for application of RF voltages thereto to generate an electromagnetic field within said passageway for providing radial confinement of the ions and further configured for application of a DC voltage thereto,
at least two pairs of auxiliary electrodes interspersed between said plurality of rods and configured for application of DC bias voltages thereto,
wherein the DC bias voltages applied to the auxiliary electrodes are configured relative to said DC voltage applied to said plurality of rods such that ions having m/z ratios within a target range experience stable trajectories as they pass through the passageway and ions having m/z ratios outside said target range experience unstable trajectories so as to be deposited on one of said pairs of the auxiliary electrodes based on an electric charge of the ions and the polarities of the DC bias voltages applied to said auxiliary electrodes relative to said DC voltage.

18. The mass spectrometer of claim 17, wherein at least a portion of said unstable ions is deposited on the pair of the auxiliary electrodes that is maintained at a DC bias voltage that is positive relative to said DC voltage applied to said multipole rods when said ions have a negative electric charge and at least a portion of said unstable ions is deposited on the pair of the auxiliary electrodes that is maintained at a DC bias voltage that is negative relative to the DC voltage applied to said multipole rods when the ions have a positive electric charge.

19. The mass spectrometer of claim 17, further comprising at least one DC voltage source configured to apply said DC voltage to said plurality of multipole rods and said DC bias voltages to said auxiliary electrodes.

20. The mass spectrometer of claim 19, further comprising a controller in communication with said at least one DC voltage source, wherein the controller is configured to cause said DC voltage source to switch a polarity of the DC bias voltage differential between said pair of the auxiliary electrodes so as to change the pair of the auxiliary electrodes on which said unstable ions are deposited.
